(19) United States
(12) Patent Application Publication
(10) Pub. No.: US 2023/0088328 A1
(43) Pub. Date: Mar. 23, 2023

(54) SYSTEM AND METHOD FOR CRIME RISK FORECASTING USING CYBER SECURITY AND DEEP LEARNING

(71) Applicants: Abdulwasa Bakr Barnawi, Abha (SA); Neeraj Kumar Shukla, Abha (SA); Vineet Tirth, Abha (SA); Javed Khan Bhutto, Abha (SA); M. Ramkumar Raja, Abha (SA); Rajesh Verma, Abha (SA); Samidha Dwivedi Sharma, Abha (SA); Vivek Kumar, Roorkee (IN); Pawan Kumar Singh, Navi Mumbai (IN); B.K. Sarkar, Navi Mumbai (IN)

(72) Inventors: Abdulwasa Bakr Barnawi, Abha (SA); Neeraj Kumar Shukla, Abha (SA); Vineet Tirth, Abha (SA); Javed Khan Bhutto, Abha (SA); M. Ramkumar Raja, Abha (SA); Rajesh Verma, Abha (SA); Samidha Dwivedi Sharma, Abha (SA); Vivek Kumar, Roorkee (IN); Pawan Kumar Singh, Navi Mumbai (IN); B.K. Sarkar, Navi Mumbai (IN)

(21) Appl. No.: 18/058,716

(22) Filed: Nov. 23, 2022

(51) Int. Cl. G08B 25/01; G06Q 50/26

(52) U.S. Cl. CPC G08B 25/016; G06Q 50/265

(57) ABSTRACT

The present disclosure generally relates to a system for crime risk forecasting using cyber security and deep learning comprises a data input unit for receiving a pre-stored crime event dataset and real time crime event data input along with geographical details of an area; a classification processing unit for categorizing pre-stored crime event dataset and real time crime event data input according to crime type; a graphical user interface for entering a target geographic area for forecasting upcoming crime risk; a central processing unit for generating a crime risk forecast based on the historical crime incident stored in the pre-stored crime event dataset using a deep leaning technique; and a control unit coupled to a display for displaying a crime risk ranking generated based on the crime risk forecast and one or more crime risk event for the target geographic area.

### TECHNICAL FIELD

The present disclosure relates to early crime event forecasting systems, in more details, a system and method for crime risk forecasting using cyber security and deep learning.

### BACKGROUND

A subfield of artificial intelligence known as computer vision teaches computers how to interpret and grasp the visual environment, giving them an awareness of their surroundings. Artificial intelligence's field of computer vision teaches machines to interpret the visual world and, as a result, develops a sense of awareness of their surroundings. Costs associated with criminal activity may affect both the public and private sectors. When people travel or relocate, public safety plays a significant role in creating secure settings. In truth, different criminal offenses may have varied repercussions. In general, crimes occur because of a variety of factors, including particular reasons, human nature and behaviour, dire circumstances, and poverty.

Because it supports the ability of investigation authorities to handle crime computationally, crime prediction has grown in prominence in recent years. Although challenging, accurate crime prediction is essential for preventing criminal activity. Numerous computational opportunities and problems are presented by the precise calculation of the crime rate, types, and hotspots from historical trends. The current standard for prediction analysis is crime prediction based on machine learning, however just a few research systematically compare various machine learning approaches. In numerous disciplines, including crime prediction, the capability of machine learning algorithms to process non-linear rational data has been demonstrated. It can extract the properties of the data and handle very high-dimensional data with faster training times.

The existing systems lack in the relative accuracy for crime prediction from huge datasets for numerous cities, despite significant research efforts. The existing approaches, however, fail to pinpoint connections between certain behaviours and crimes like drug trafficking and financial crimes. In the view of the forgoing discussion, it is clearly portrayed that there is a need to have a system and method for crime risk forecasting using cyber security and deep learning.

### BRIEF SUMMARY

The present disclosure seeks to provide an intelligent system and method for forecasting upcoming crime event and alerting the rescue personnel according to the type of the upcoming crime event using cyber security and deep learning.

In an embodiment, a system for crime risk forecasting using cyber security and deep learning is disclosed. The system includes a data input unit for receiving a pre-stored crime event dataset and real time crime event data input along with geographical details of an area.

The system further includes a classification processing unit for categorizing pre-stored crime event dataset and real time crime event data input according to crime type. The system further includes a graphical user interface for entering a target geographic area for forecasting upcoming crime risk.

The system further includes a central processing unit connected to the graphical user interface for generating a crime risk forecast based on the historical crime incident stored in the pre-stored crime event dataset using a deep leaning technique, wherein the crime risk forecast is generated for a target geographic area for future time window and a crime type.

The system further includes a control unit coupled to a display and the graphical user interface for displaying a crime risk ranking generated based on the crime risk forecast and one or more crime risk event for the target geographic area, wherein the graphical user interface visually indicates the future time window of the generated crime risk forecast, the graphical user interface visually indicates the crime type of the generated crime risk forecast, and indicates the target geographic area of the generated crime risk forecast on a cooperating geospatial map.

In one embodiment, the pre-stored crime event dataset connected to a cloud server to store historical criminal event data enlightening a plurality of crimes committed over a period of time in the past.

In one embodiment, the central processing unit comprises a crime risk forecast model trained through the deep learning technique using the pre-stored crime event dataset for generating a crime risk forecast.

In one embodiment, the crime risk forecast model is configured to assign weights to the plurality of crimes committed over a period of time in the past based on a correlation to the crime type, wherein weights to the plurality of crimes are assigned upon determining the correlation to the crime type by calculating an implication of the first crime type from a presence of a second crime type in the crime data.

In one embodiment, the future time window corresponds to a future law enforcement patrol shift, with the latter shift corresponding to a periodically recurring continuous period of time, wherein the graphical user interface displays the future law enforcement patrol shift, and it further displays each of a number of periodically recurring continuous sub-time periods of the periodically recurring continuous.

In one embodiment, the cooperating geospatial map produced by the geospatial application includes a set of features selected from a group of roads, terrain, lakes, rivers, vegetation, utilities, street lights, railroads, hotels or motels, schools, hospitals, buildings or structures, regions, transportation objects, entities, events, or documents.

In one embodiment, the system comprises an alert unit connected to the control unit for generating an alert notification thereby transferring the alert notification to a registered personnel/an inspection group according to the forecast crime event type via a communication device to alert the registered personnel/inspection group to stop the forecasted upcoming crime event.

In another embodiment, a method for crime risk forecasting using cyber security and deep learning is disclosed. The method includes receiving a pre-stored crime event dataset and real time crime event data input along with geographical details of an area through a data input unit.

The method further includes categorizing pre-stored crime event dataset and real time crime event data input according to crime type using a classification processing unit. The method further includes entering a target geographic area for forecasting upcoming crime risk via a graphical user interface.

The method further includes generating a crime risk forecast based on the historical crime incident stored in the pre-stored crime event dataset using a deep leaning technique using a central processing unit, wherein the crime risk forecast is generated for a target geographic area for future time window and a crime type.

The method further includes displaying a crime risk ranking on a display and the graphical user interface generated based on the crime risk forecast and one or more crime risk event for the target geographic area by a control unit, wherein the graphical user interface visually indicates the future time window of the generated crime risk forecast, the graphical user interface visually indicates the crime type of the generated crime risk forecast, and indicates the target geographic area of the generated crime risk forecast on a cooperating geospatial map.

In one embodiment, the crime risk forecast generation comprises instructions for generating the crime risk forecast based at least on custody information reflecting release from custody of one or more persons known to have committed one or more of the historical crime incidents in the particular target geographic area.

In one embodiment, the instructions for generating the crime risk forecast comprise: producing a first crime risk value based weighted sum of the historical crime events within a space threshold and a time threshold for the target geographic area, the future time window, and the crime type; producing a second crime risk value using a sum of the historical crime events; and producing a third crime risk value using the deep leaning technique upon evaluating the first crime risk value and the second crime risk value.

An object of the present disclosure is to forecast upcoming crime event based on a target geographic area for future time window and a crime type.

Another object of the present disclosure is to alert the rescue personnel according to the type of the upcoming crime event using cyber security and deep learning.

Another object of the present disclosure is to assist in stopping the upcoming crime event upon predicting the early crime event.

Yet another object of the present disclosure is to deliver an expeditious and cost-effective method for crime risk forecasting using cyber security and deep learning.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a system for crime risk forecasting using cyber security and deep learning in accordance with an embodiment of the present disclosure;

FIG. 2 illustrates a flow chart of a method for crime risk forecasting using cyber security and deep learning in accordance with an embodiment of the present disclosure; and

FIG. 3 illustrates a system architecture for early crime event forecasting in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

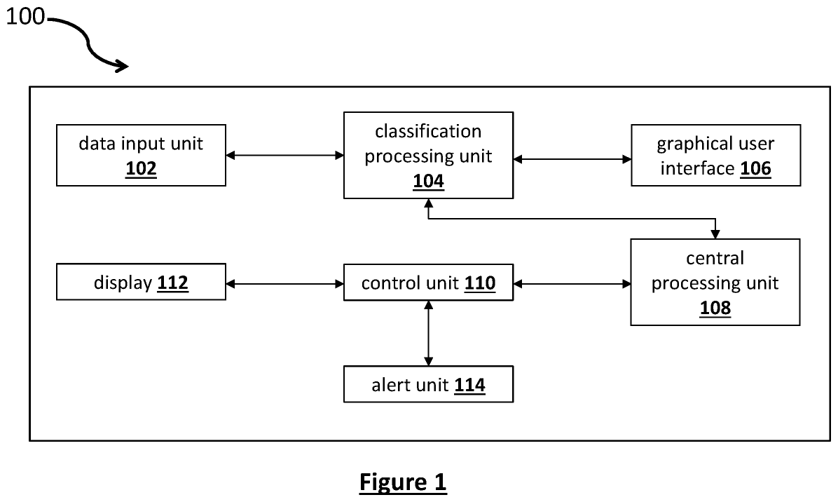

Referring to FIG. 1, a block diagram of a system for crime risk forecasting using cyber security and deep learning is illustrated in accordance with an embodiment of the present disclosure. The system 100 includes a data input unit 102 for receiving a pre-stored crime event dataset and real time crime event data input along with geographical details of an area.

In an embodiment, a classification processing unit 104 is connected to the data input unit 102 for categorizing pre-stored crime event dataset and real time crime event data input according to crime type.

In an embodiment, a graphical user interface 106 is connected to the classification processing unit 104 for entering a target geographic area for forecasting upcoming crime risk.

In an embodiment, a central processing unit 108 is connected to the graphical user interface 106 for generating a crime risk forecast based on the historical crime incident stored in the pre-stored crime event dataset using a deep leaning technique, wherein the crime risk forecast is generated for a target geographic area for future time window and a crime type.

In an embodiment, a control unit 110 is coupled to a display 112 and the graphical user interface 106 for displaying a crime risk ranking generated based on the crime risk forecast and one or more crime risk event for the target geographic area, wherein the graphical user interface 106 visually indicates the future time window of the generated crime risk forecast, the graphical user interface 106 visually indicates the crime type of the generated crime risk forecast, and indicates the target geographic area of the generated crime risk forecast on a cooperating geospatial map.

In one embodiment, the pre-stored crime event dataset connected to a cloud server 118 to store historical criminal event data enlightening a plurality of crimes committed over a period of time in the past.

In one embodiment, the central processing unit 108 comprises a crime risk forecast model 116 trained through the deep learning technique using the pre-stored crime event dataset for generating a crime risk forecast.

In one embodiment, the crime risk forecast model 116 is configured to assign weights to the plurality of crimes committed over a period of time in the past based on a correlation to the crime type, wherein weights to the plurality of crimes are assigned upon determining the correlation to the crime type by calculating an implication of the first crime type from a presence of a second crime type in the crime data.

In one embodiment, the future time window corresponds to a future law enforcement patrol shift, with the latter shift corresponding to a periodically recurring continuous period of time, wherein the graphical user interface 106 displays the future law enforcement patrol shift, and it further displays each of a number of periodically recurring continuous sub-time periods of the periodically recurring continuous.

In one embodiment, the cooperating geospatial map produced by the geospatial application includes a set of features selected from a group of roads, terrain, lakes, rivers, vegetation, utilities, street lights, railroads, hotels or motels, schools, hospitals, buildings or structures, regions, transportation objects, entities, events, or documents.

In one embodiment, the system comprises an alert unit 114 connected to the control unit 110 for generating an alert notification thereby transferring the alert notification to a registered personnel/an inspection group according to the forecast crime event type via a communication device 120 to alert the registered personnel/inspection group to stop the forecasted upcoming crime event.

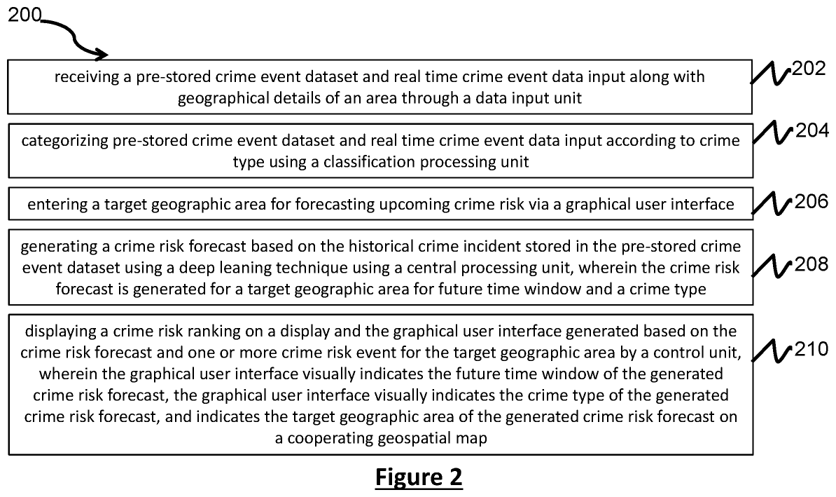

FIG. 2 illustrates a flow chart of a method for crime risk forecasting using cyber security and deep learning in accordance with an embodiment of the present disclosure. At step 202, the method 200 includes receiving a pre-stored crime event dataset and real time crime event data input along with geographical details of an area through a data input unit 102.

At step 204, the method 200 includes categorizing pre-stored crime event dataset and real time crime event data input according to crime type using a classification processing unit 104.

At step 206, the method 200 includes entering a target geographic area for forecasting upcoming crime risk via a graphical user interface 106.

At step 208, the method 200 includes generating a crime risk forecast based on the historical crime incident stored in the pre-stored crime event dataset using a deep leaning technique using a central processing unit 108, wherein the crime risk forecast is generated for a target geographic area for future time window and a crime type.

At step 210, the method 200 includes displaying a crime risk ranking on a display 112 and the graphical user interface 106 generated based on the crime risk forecast and one or more crime risk event for the target geographic area by a control unit 110, wherein the graphical user interface 106 visually indicates the future time window of the generated crime risk forecast, the graphical user interface 106 visually indicates the crime type of the generated crime risk forecast, and indicates the target geographic area of the generated crime risk forecast on a cooperating geospatial map.

In one embodiment, the crime risk forecast generation comprises instructions for generating the crime risk forecast based at least on custody information reflecting release from custody of one or more persons known to have committed one or more of the historical crime incidents in the particular target geographic area.

In one embodiment, the instructions for generating the crime risk forecast includes producing a first crime risk value based weighted sum of the historical crime events within a space threshold and a time threshold for the target geographic area, the future time window, and the crime type. Then, producing a second crime risk value using a sum of the historical crime events. Then, producing a third crime risk value using the deep leaning technique upon evaluating the first crime risk value and the second crime risk value.

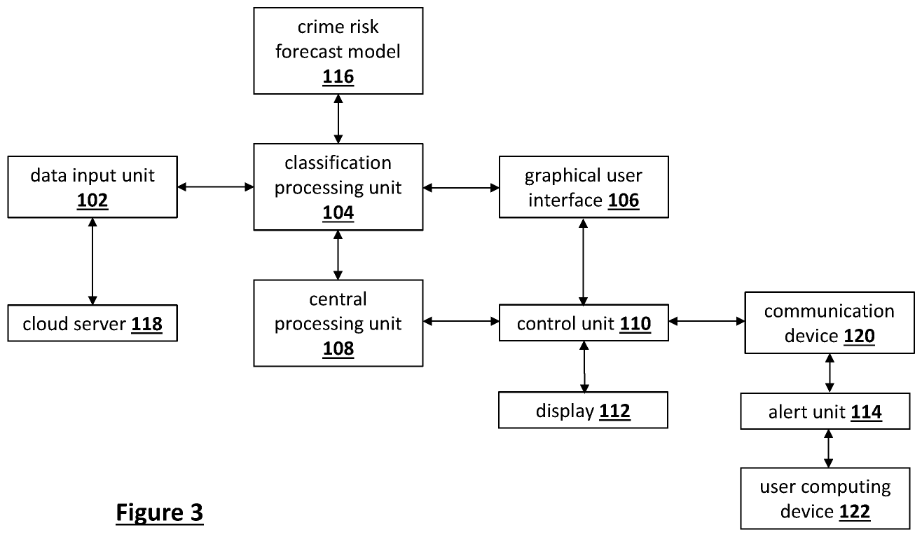

FIG. 3 illustrates a system architecture for early crime event forecasting in accordance with an embodiment of the present disclosure. The data input unit 102 is configured with the cloud server 118 for receiving a pre-stored crime event dataset and real time crime event data input along with geographical details of an area.

In one embodiment, the classification processing unit 104 is configured for categorizing pre-stored crime event dataset and real time crime event data input according to crime type, wherein the crime type is selected from a group of one or more general personal and property crimes including assault, battery, kidnapping, homicide, offenses of a sexual nature, larceny (theft), robbery (theft by force), vehicle theft, burglary, arson, and the like.

In one embodiment, the graphical user interface 106 provides a questionnaire allowing user to enter a target geographic area for forecasting upcoming crime risk, wherein the graphical user interface 106 also displays determined crime type.

In one embodiment, the central processing unit 108 generates a crime risk forecast for a target geographic area for future time window and a crime type using a deep leaning technique.

In one embodiment, the control unit 110 generating a crime risk ranking based on the crime risk forecast and one or more crime risk event for the target geographic area and displaying on the display 112 and the graphical user interface 106 with geographical location and expected crime event timing.

In one embodiment, the alert unit 114 is configured to alert the registered personnel/an inspection group by transferring the alert notification to a user computing device 122 via the communication device 120 to stop the forecasted upcoming crime event as soon as possible.

In another embodiment, the crime risk forecast model 116 is trained through the deep learning technique using the pre-stored crime event dataset, wherein the crime risk forecast model 116 is trained continuously using the new and future crime events.

The functional units described in this specification have been labeled as devices. The functional units includes data input unit 102, classification processing unit 104, graphical user interface 106, central processing unit 108, control unit 110, display 112, alert unit 114, crime risk forecast model 116, cloud server 118, communication device 120, and the user computing device 122. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for crime risk forecasting using cyber security and deep learning, the system comprises:
a data input unit for receiving a pre-stored crime event dataset and real time crime event data input along with geographical details of an area;
a classification processing unit for categorizing pre-stored crime event dataset and real time crime event data input according to crime type;
a graphical user interface for entering a target geographic area for forecasting upcoming crime risk;
a central processing unit connected to the graphical user interface for generating a crime risk forecast based on the historical crime incident stored in the pre-stored crime event dataset using a deep leaning technique, wherein the crime risk forecast is generated for a target geographic area for future time window and a crime type; and
a control unit coupled to a display and the graphical user interface for displaying a crime risk ranking generated based on the crime risk forecast and one or more crime risk event for the target geographic area, wherein the graphical user interface visually indicates the future time window of the generated crime risk forecast, the graphical user interface visually indicates the crime type of the generated crime risk forecast, and indicates the target geographic area of the generated crime risk forecast on a cooperating geospatial map.

2. The system as claimed in claim 1, wherein the pre-stored crime event dataset connected to a cloud server to store historical criminal event data enlightening a plurality of crimes committed over a period of time in the past.

3. The system as claimed in claim 1, wherein the central processing unit comprises a crime risk forecast model trained through the deep learning technique using the pre-stored crime event dataset for generating a crime risk forecast.

4. The system as claimed in claim 3, wherein the crime risk forecast model is configured to assign weights to the plurality of crimes committed over a period of time in the past based on a correlation to the crime type, wherein weights to the plurality of crimes are assigned upon determining the correlation to the crime type by calculating an implication of the first crime type from a presence of a second crime type in the crime data.

5. The system as claimed in claim 1, wherein the future time window corresponds to a future law enforcement patrol shift, with the latter shift corresponding to a periodically recurring continuous period of time, wherein the graphical user interface displays the future law enforcement patrol shift, and it further displays each of a number of periodically recurring continuous sub-time periods of the periodically recurring continuous.

6. The system as claimed in claim 1, wherein the cooperating geospatial map produced by the geospatial application includes a set of features selected from a group of roads, terrain, lakes, rivers, vegetation, utilities, street lights, railroads, hotels or motels, schools, hospitals, buildings or structures, regions, transportation objects, entities, events, or documents.

7. The system as claimed in claim 1, wherein said system comprises an alert unit connected to the control unit for generating an alert notification thereby transferring the alert notification to a registered personnel/an inspection group according to the forecast crime event type via a communication device to alert the registered personnel/inspection group to stop the forecasted upcoming crime event.

8. A method for crime risk forecasting using cyber security and deep learning, the method comprises:
receiving a pre-stored crime event dataset and real time crime event data input along with geographical details of an area through a data input unit;
categorizing pre-stored crime event dataset and real time crime event data input according to crime type using a classification processing unit;
entering a target geographic area for forecasting upcoming crime risk via a graphical user interface;
generating a crime risk forecast based on the historical crime incident stored in the pre-stored crime event dataset using a deep leaning technique using a central processing unit, wherein the crime risk forecast is generated for a target geographic area for future time window and a crime type; and
displaying a crime risk ranking on a display and the graphical user interface generated based on the crime risk forecast and one or more crime risk event for the target geographic area by a control unit, wherein the graphical user interface visually indicates the future time window of the generated crime risk forecast, the graphical user interface visually indicates the crime type of the generated crime risk forecast, and indicates the target geographic area of the generated crime risk forecast on a cooperating geospatial map.

9. The method as claimed in claim 8, wherein the crime risk forecast generation comprises instructions for generating the crime risk forecast based at least on custody information reflecting release from custody of one or more persons known to have committed one or more of the historical crime incidents in the particular target geographic area.

10. The method as claimed in claim 8, wherein the instructions for generating the crime risk forecast comprise:
producing a first crime risk value based weighted sum of the historical crime events within a space threshold and a time threshold for the target geographic area, the future time window, and the crime type;
producing a second crime risk value using a sum of the historical crime events; and
producing a third crime risk value using the deep leaning technique upon evaluating the first crime risk value and the second crime risk value.
